(19) United States
(12) Patent Application Publication
(10) Pub. No.: US 2008/0264302 A1
(43) Pub. Date: Oct. 30, 2008

(54) Curable Composition Containing as Constituent Material Silica Obtained by Decomposing Chrysotile and Cured Object

(75) Inventors: Masahiko Azui, Hyogo (JP); Tetsuya Shimamura, Hyogo (JP); Kiyotsugu Yamashita, Hyogo (JP)

Correspondence Address: GREENBLUM & BERNSTEIN, P.L.C., 1950 ROLAND CLARKE PLACE, RESTON, VA, 20191, US

(73) Assignee: NOZAWA CORPORATION, Hyogo (JP)

(21) Appl. No.: 11/577,854

(22) PCT Filed: Oct. 24, 2005
(86) PCT No.: PCT/JP05/19507

§ 371 Date: Mar. 21, 2008

(30) Foreign Application Priority Data
Oct. 25, 2004 (JP) 2004-309475

(51) Int. Cl. C04B 14/38; C01B 33/24

(52) U.S. Cl. 106/711; 423/331

(57) ABSTRACT

Chrysotile or chrysotile-containing serpentinite containing chrysotile is treated to convert the chrysotile contained therein into a non-asbestos material, so that the non-asbestos material is used as a material that can be recycled safely and is effective from the view point of environmental protection.

[Means for Solving Problems] A curable composition characterized by containing at least a porous fibrous amorphous silica obtained by decomposing chrysotile or chrysotile-containing serpentinite with acid to substantially eliminate an influence of asbestos on living body, and a reinforcing fiber. The curable composition preferably contains a surfactant and a thickener and/or a filler and/or a colorant or an air-hardening material and/or water-hardening material and a thickener. The composition preferably contains 15 to 100% of the porous fibrous amorphous silica obtained by decomposing the chrysotile or the chrysotile-serpentinite with acid, 0 to 75% of a slaked line, 0 to 3% of a thickener, and 0 to 10% of a pulp.

### FIELD OF THE INVENTION

This invention relates to a curable composition containing silica obtained by decomposing chrysotile and as a constituent material, further, to a coating composition and a cured material obtained by using the curable composition, which is usable in the fields of building and civil engineerings.

### BACKGROUND ART

Recently, in detached houses and collective housings, new building materials such as a vinyl cloth and a printed plywood have come to be used as interior materials for finishing surfaces of walls and a ceiling of a room from the view points of construction and economic efficiencies. However, traces of chemical substances such as formalin, ammonia, and organic solvents remain in such building materials, and it has been pointed out that the room is contaminated by gases discharged to the room from such chemical substances. Chemical substances remaining in a trace amount are harmful to humans and can be the causes of allergies, atopic dermatitis, asthma, headache, and so forth. Particularly, the sick house syndrome has become a social issue, and there are an increasing number of approaches to resolution for the sick house problem caused by chemical substances.

In order to solve the above-described environmental issue, many interior finishing materials that contain as a main ingredient diatom earth having a moisture absorption/desorption property, an odor absorption property, and a chemical substance absorption property have been used, and, for example, Patent Publication 1 discloses a composition for a coating material containing diatom earth, a hydraulic setting material, and a chemical substance absorption material. Also, Patent Publication 2 discloses a coating composition for building use containing slaked lime, diatom earth, and an acryl resin-based emulsion.

However, since the conventional compositions are not solidified only with the use of the diatom earth, the hydraulic setting material or the resin-based emulsion is added thereto. Therefore, a proportion of the diatom earth is reduced to inevitably reduce the moisture absorption/desorption property as compared to the use of diatom earth only, and, also, fear for the sick house raised by the use of chemical substances has still been pointed out. Further, since the diatom earth is a natural material, it tends to cause a variation in color tone, and a countermeasure for such variation is required.

On the other hand, as a material having the moisture absorption/desorption property, the odor absorption property, and the chemical substance absorption property equal to or better than those of the diatom earth, Patent Publications 3 and 4 disclose a fibrous silica obtained by decomposing chrysotile or serpentinite with acid and propose applications thereof. However, the applications are not yet specific enough.

### Patent Publication 1: JP-A-2003-183067

### Patent Publication 2: JP-A-2002-317143

### Patent Publication 3: JP-A-1-261218

### Patent Publication 4: JP-A-2004-75531

Also, the heat island phenomenon of urban areas has been aggravated so as to harm residential environments, and measures for this problem have been implemented. In addition to afforestation promotion, a method of suppressing a temperature rise by causing water retentive materials to consume the heat as vaporization heat and like methods have been practically employed mainly for pavement materials and the like.

### DISCLOSURE OF THE INVENTION

### Problems to be Resolved by the Invention

Since diatom earth which is used as a plaster for interior finishing material does not contain a self-solidifying component, it is necessary to use white lime or the like as an air-hardening component. Also, in the case of producing a product having a high moisture absorption/desorption property, since adhesion to a base material is reduced when the air-hardening component is reduced, it is impossible to increase a content of the diatom earth without limitation, resulting in a product limited in the moisture absorption/desorption property and the chemical substance absorption property.

Further, since the diatom earth is a natural material, it has been pointed out that a color tone of a finished surface thereof lacks in stability. Since the diatom earth varies in color by a lot, a problem of change in color tone on one wall surface is raised when different lots of diatom earth are used for the wall surface. In order to avoid such problem, an extra diatom earth is usually prepared to avoid shortage of the material, but such countermeasure increases cost since the diatom earth is an expensive material. Also, when the content of diatom earth is reduced for the purpose of avoiding the above problems, a moisture absorption/desorption property, an odor absorption property, and a harmful substance absorption property are reduced, thereby failing to exhibit required indoor environment improvement properties.

Also, products in the form of a tile (products obtained by sintering allophane, diatom earth, etc.) have been known as anti-sick house building materials, and such products are obtained by performing sintering as a solidifying method. However, it is considered that functionalities (humidity conditioning and deodorizing properties) are reduced due to the sintering, though the sintering imparts strength to the hardened matter. The diatom earth can be mixed with a material having a hardening property (white lime, cement, resin, etc.) for molding and solidification, but a content of the diatom earth is reduced due to the mixing, thereby failing to exhibit the required indoor environment improvement properties.

As a material for suppressing the heat island phenomenon, materials obtained by mixing a cured material such as a pavement material with a water-absorbing resin or sepiolite have been used. However, the water-absorbing resin has a problem in durability, and there is a possibility of asbestos contamination in the sepiolite. Therefore, use of these materials has been waived.

On the other hand, since the asbestos which has widely been used as being contained in building materials and the like can invoke severe diseases such as lung cancer and mesothelial tumor after an incubation period of about 30 years in respiratory organs when it was inhaled, use thereof is being banned internationally. Among the types of asbestos, chrysotile is used in the largest amount, and the amount used as building materials is enormous, thereby raising a problem of treating such products when they are discarded.

At present, the waste is buried or fused at a high temperature without any other options, and, in view of the continuing reduction in capacity of waste treatment plants, potential danger of ground burial, enormous cost for fusing, and the like, questions have been raised about safe and reliable treatment in future.

The base rock of chrysotile is serpentinite, and the serpentinite exists as a natural resource widely in Japan and all over the world and has been used as an iron slag forming agent, as crushed stone, and as an additive for mortar, resins, and the like. The serpentinite differs in chrysotile content depending on the place of origin, but it can be said that serpentinite which does not contain chrysotile does not exist.

Therefore, safe recycle of the chrysotile contained in asbestos-containing products and the chrysotile contained in the serpentinite by converting the chrysotile into a non-asbestos material is extremely important for future environment protection. However, almost all of the technologies that have heretofore been disclosed do not clearly have the ability to eliminate harmfulness of the chrysotile though they disclose the conditions for conversion into non-asbestos material, and, as the matter now stands, it has not been verified whether or not it is possible to implement safe recycling. Also, few of the conventional technologies disclose a promising application for the enormous amount of recycled matter that would be produced.

An object of this invention is to provide a curable composition obtained by treating chrysotile and chrysotile-containing serpentinite and solving the above-described problems of diatom earth, particularly, a coating composition excellent in workability as an interior finishing material for plastering.

Another object of this invention is to provide a coating composition for interior using a material which is versatile, low price, effective as a use for recycled asbestos, having a moisture conditioning function, and useful for improving indoor environment. Further, this invention provides a curing agent usable for an interior material and the like which needs curing properties.

Yet another object of this invention is to make it possible to safely recycle chrysotile by converting chrysotile and chrysotile-containing serpentinite into a non-asbestos material. This is an extremely important object from the view point of future environment protection, and, particularly, it is intended to obtain a useful material by converting chrysotile contained in asbestos-containing products into non-asbestos material.

### Means of Solving the Problems

This invention provides a curable composition that makes possible useful applications for porous fibrous amorphous silica (hereinafter sometimes referred to as fibrous silica) obtainable by treating chrysotile and chrysotile-containing serpentinite.

(1) A curable composition characterized by comprising a porous fibrous amorphous silica obtained by decomposing a chrysotile or a serpentinite containing a chrysotile with acid to substantially eliminate an influence of asbestos to living body.

(2) The curable composition according to the above (1), characterized by including a reinforcing fiber and/or a surfactant and a thickener and/or a filler and/or a colorant in the curable composition.

(3) The curable composition according to the above (1) or (2), characterized by including an air-hardening material and/or a water-hardening material and a thickener in the curable composition.

(4) The curable composition according to any one of the above (1) to (3), characterized by including: 15 to 100% of the porous fibrous amorphous silica obtained by decomposing a chrysotile or a serpentinite containing a chrysotile with acid; 0 to 75% of a slaked lime; 0 to 3% of the thickener; 0 to 10% of a pulp; and 0 to 75% of the filler.

(5) The curable composition according to the above (3) or (4), characterized by including at least one of a methylcellulose, a starch glue, and a seaweed glue as the thickener.

(6) A coating composition using the curable composition according to any one of the above (1) to (5), the curable composition is characterized by comprising a porous fibrous amorphous silica obtained by decomposing a chrysotile or a serpentinite containing a chrysotile with acid to substantially eliminate an influence of asbestos to living body.

(7) A cured material obtained by extrusion or press-molding, characterized by comprising a porous fibrous amorphous silica obtained by decomposing a chrysotile or a serpentinite containing a chrysotile with acid to substantially eliminate an influence of asbestos to living body.

(8) A cured material obtained by extruding or press-molding the curable composition according to any one of the above (1) to (5), the curable composition is characterized by comprising a porous fibrous amorphous silica obtained by decomposing a chrysotile or a serpentinite containing a chrysotile with acid to substantially eliminate an influence of asbestos to living body.

### Advantageous Effects of the Invention

The curable composition obtained by this invention is usable as a wet-type interior finishing material having humidity conditioning and deodorizing properties due to a moisture absorption/desorption property, a gas absorption property, a water retention property, and the like of the porous fibrous amorphous silica. Also, the curable composition is usable as a dry interior material having humidity conditioning and deodorizing properties, an exterior wall material, a floor material, and a pavement material having water retention property and, further, is applied to a use as a material to mitigate the heat island phenomenon.

The curable composition of this invention is usable as a coating composition, i.e., as a wet interior finishing material for plastering and capable of achieving an indoor environment improvement function superior to diatom earth by using the porous fibrous amorphous silica as a material for moisture absorption/desorption and odor absorption. Also, it is possible to obtain a finishing material for plastering that: is easily constructed due to water retention property and thixotropy of the porous fibrous amorphous silica; improves structural soundness when the pulp is added; does not require a setting bed; and is free from crack after construction. Further, since the porous fibrous amorphous silica has a dry-hardening property, solidification is achieved without an air-hardening component such as white lime. This invention eliminates fear for environmental pollution by harmful gases such as formalin generated with the use of the porous fibrous amorphous silica and is suitable for interior and exterior of independent houses, collective houses such as an apartment flat, and community facilities such as a hospital.

The coating composition of this invention provides the following interior finishing materials due to its excellent properties.

(a) A wet interior finishing material that is easily used, free from crack, and excellent in indoor environment improvement properties.
(b) An interior finishing material excellent in stability in color tone in finishing.
(e) An interior finishing material reduced in biological influence.

The cured material obtained from the curable composition of this invention is solidified only by drying after molding since the porous fibrous amorphous silica has the dry-hardening property and thus is reduced in energy required for molding as compared to sintering, and is free from a reduction in performance due to solidification. Thus, it is possible to provide the cured material having excellent indoor environment improvement properties and reduced biological influence similar to those of the coating composition at a low cost.

Also, the cured material obtained from the curable composition of this invention is utilized as an effective material for a pavement material and an exterior material as a water-retaining cured material which is of practical use for heat island countermeasure since the porous fibrous amorphous silica is excellent in water retention property and moisture retention property and easily molded.

Further, the fibrous silica to be used in this invention can be produced from chrysotile separated and collected from existing asbestos-containing building materials and thus is useful for recycle of the asbestos-containing building materials that have been considered to be hard to recycle.

According to this invention, by producing porous fibrous amorphous silica from which the harmful properties of chrysotile have been eliminated though conversion into the non-asbestos material by decomposing chrysotile or chrysotile containing serpentinite in an acidic solution, it is possible to use the porous fibrous amorphous silica as a functionality imparting material that: takes advantage of its porous and fibrous form; is excellent in functions such as moisture conditioning, deodorization, and water retention; and has applications whose future demand will surely increase.

Further, enormous amounts of waste or unused resources containing chrysotile will be generated in the future, and this invention enables effective usage of this waste and resource by providing applications with sure future demand, and converting the chrysotile or the chrysotile-containing material into a material that can be handled safely.

### BEST MODE FOR CARRYING OUT THE INVENTION

Hereinafter, the best mode for carrying out this invention will be described in detail.

In this invention, a porous fibrous amorphous silica is obtained by pulverizing and classifying chrysotile and/or serpentinite containing chrysotile or asbestos-containing building materials, and decomposing this chrysotile with mineral acid, and eluting magnesia from it.

(A) Chrysotile and/or serpentinite containing chrysotile are/is pulverized. A grain size of the serpentinite may preferably be 22 μm or less in order to perform the decomposition efficiently. The chrysotile is not necessarily be pulverized and can be decomposed as it is.

(B) The pulverized chrysotile and/or the chrysotile-containing serpentinite are/is thrown into an acid solution followed by decomposition with stirring. Though the type of the acid to be used is not particularly limited, a mineral acid is ordinarily used, and, from the view points of reactivity, reaction speed, and cost, sulfuric acid, chloric acid, and nitric acid are usable without particular limitation thereto. The usage amount of the acid may be twice or more, preferably 2.3 times or more, the equivalent weight of magnesia (MgO) contained in the chrysotile and/or the chrysotile-containing serpentinite, and it is possible to obtain the target silica by stirring at 100° C. for 1 hour or more, preferably 2 hours or more.

(C) After termination of the decomposition, residual silica remaining as a residue of dissolution is collected by filtration, and then residual acid is eliminated by washing with water, followed by drying, thereby obtaining the porous fibrous amorphous silica. Since the washing is time-consuming, the residual acid may be eliminated by neutralization with a neutralizer. As the neutralizer, a caustic soda, calcium carbonate, slaked lime, magnesium hydroxide, magnesium oxide, and the like are usable.

The obtained porous fibrous amorphous silica has the following properties.

(a) The porous fibrous amorphous silica obtained by decomposing the chrysotile or the chrysotile-containing serpentinite with acid retains the original structure (chrysotile structure) and has a hollow fiber structure.

(b) The pore diameter of the porous fibrous silica is several nanometers, and the pore volume is larger than that of diatom earth which has a high moisture absorption/desorption property.

(c) The specific surface area of the amorphous silica achieved by the MgO dissociation by the acid treatment is 200 to 300 m²/g which is considerably larger than that of the diatom earth. Therefore, the amorphous silica is porous and fibrous and excellent in moisture absorption/desorption property, gas absorption property, and water retention property.

(d) The porous fibrous amorphous silica has a dry-hardening property which enables solidification by drying when extruded or press-molded after being mixed with water, without addition of a water-hardening material or an air-hardening material.

(e) The asbestos (chrysotile) is amorphized through the decomposition with acid.

(f) The biological influence of the porous fibrous amorphous silica generated by the decomposition with acid is largely reduced, and carcinogenicity disappears therefrom, thereby substantially ensuring the safety.

In the case of using the porous fibrous amorphous silica as a moisture absorption/desorption material, the moisture absorption/desorption material contributes to ensuring workability in the case of wet construction in plastering work since it is superior in moisture absorption/desorption property and odorant absorption property to diatom shale which is considered to have the highest effectiveness among the diatom earths and since it is excellent in water retention property and thixotropy.

Also, since the porous fibrous amorphous silica is mass-produced under industrially controlled conditions, the porous fibrous amorphous silica has stable properties and is uniform in color tone and free from color tone variation like the diatom earth which is a natural material. Accordingly, with the use of the porous fibrous amorphous silica, unlike diatom earth-based materials, it is unnecessary to prepare an extra material for use in construction or to increase content of other material, and the porous fibrous amorphous silica is highly effective and capable of exhibiting required indoor environment improvement properties.

The porous fibrous amorphous silica to be used in this invention does not contain crystalline silica which is considered to be harmful.

From experimental results using cultured cells, cell toxicity of the porous fibrous amorphous silica is the lowest among inorganic fibrous substances, at a similar level to wollastonite whose noncarcinogenicity is confirmed. Also, from biological fluid solubility experiments, it was confirmed that the porous fibrous amorphous silica has a higher solubility in biological fluid and lower in durability in vivo than magnesium sulfate whisker (trade name: Mos Higi: product of Ube Material Industries, Ltd.) whose safety has been confirmed.

Further, from histopathological investigations in rat endotracheal instillation experiments, prominent outbreak of fibrosis which is an index for carcinogenicity due to inhalation of a fibrous substance was confirmed with the asbestos, while no such outbreak was confirmed with the porous fibrous amorphous silica.

From the above findings, it is confirmed that the porous fibrous silica of this invention is modified into a highly safe material from which the harmful biological influence of the asbestos is disappeared.

While the diatom earth does not have a solidifying property as it is, the porous fibrous amorphous silica to be used in this invention has solidifying property when mixed with water and dried, so that it is unnecessary to add a binder or to perform a surfacing treatment for solidification. Therefore, by increasing content of the porous fibrous amorphous silica, it is possible to use the obtained coating composition as a coating composition for plastering, which has a temperature conditioning property and a deodorizing property of a higher effectiveness for a finishing material. Also, structural soundness is good in both the thick coating and thin coating, and crack does not occur after application.

As components to be contained in the curable composition, a surfactant, a thickener, a filler, and a colorant may be used. As the surfactant, it is possible to add a commercially available water reducing agent such as polycarboxylic acid-based, naphthalene sulfonic acid-based, alkylallyl sulfonic acid-based water reducing agents as a high performance water reducing agent in an amount of 0 to 0.5 wt % with respect to the solid content.

As the thickener, synthetic polymer substances such as a water-soluble cellulose-based thickener (methylcellulose, hydroxypropyl methylcellulose, hydroxyethyl methylcellulose, hydroxyethyl cellulose, hydroxyethyl ethylcellulose, carboxymethylcellulose, hydroxypropyl cellulose) and a polyvinyl alcohol-based resin as well as natural polymer substances such as starch-based, seaweed-based, and gelatin-based glues and soda alginate are usable, and it is possible to select an appropriate one from these thickeners. The thickener may be added in an amount of 0 to 1.0 wt %.

Further, as one of materials for the curable composition of this invention, an air-hardening material and/or a water-hardening material which solidifies as it dries after mixing with water may be used. The materials impart an appropriate viscosity to the coating material mixed with water, so that the coating material has a water retention property and a water absorption property, thereby improving coating workability.

Examples of the air-hardening material include slaked lime, burnt gypsum, anhydrous gypsum, magnesia cement, a dolomite plaster, and the like, and it is possible to use at least one of these air-hardening materials.

Since the slaked lime and the dolomite plaster are hardened with drying in the air after being mixed with water and then react with CO₂ in the atmosphere, a coating film is capable of absorbing the CO₂. The slaked lime is preferred as the air-hardening material to be used in this invention, and a grain diameter thereof is in the range of 50 to 200 μm. The added proportion of air-hardening material in the coating composition may be 0 to 75%, preferably 15 to 55%. It is possible to add cement as the water-hardening material.

Components other than the above may include a filler (aggregate) and the like. It is possible to add the filler for the purposes of improving designability of the finish of the coating material composition and increasing the varieties of finishes. Examples of the filler include silica sand, calcium carbonate, titanium oxide, glass beads, shirasu balloon, olivine sand, fly ash, slag, pearlite, fly ash balloon; a natural stone such as granite or marble; a mica powder; and the like.

The filler may be added in an amount of 0 to 25%, preferably 10 to 20%, in the coating material composition, but the strength of a coating film obtained after coating is reduced when the added amount exceeds 25%.

A pulp may be used as one of components to be used in this invention. The structural soundness is further improved by mixing the fibrous silica with the pulp. The pulp has an effect of preventing crack after drying and may be added in an amount of 0 to 10%.

The proportions of materials in the coating composition (interior finishing material for plastering) of this invention may be: fibrous silica 15 to 100%, preferably 40 to 80%; slaked lime 0 to 75%, preferably 16 to 55%; pulp 0 to 10%, preferably 3 to 5%; thickener 0 to 3%, preferably 0.5 to 1.0%; and filler 0 to 25%, preferably 10 to 20%.

A colorant component such as a dye may be added to the coating composition of this invention in order to add a color to a surface finishing layer to be formed.

The coating composition of this invention is obtainable by uniformly mixing the above-described materials by using a mixer or the like. A slurry of the coating material is obtained by adding water when so required to the composition obtained from the above materials and kneading. The amount of added water may be changed according to the type of the materials for the coating composition, a temperature and humidity at the point of use, and work conditions.

The coating composition has an appropriate viscosity due to the presence of water, and the slurry is plastered on inner walls of a building by using a trowel or the like. A thickness of a coating layer may be about 1.0 to 5.0 mm for interiors. This slurry hardens 6 to 48 hours after the plastering due to the air-hardening material and exhibits sufficient strength in 7 to 14 days.

Though the foregoing description has been made of the coating composition for plastering using the curable composition of this invention, since silica exhibits hardening property due to aggregation by drying, it is possible to obtain a solid matter having a desired shape by mixing an appropriate amount of water, the various surfactants and the thickener, the filler, the reinforcing fiber, the colorant, and the like followed by extrusion or press-molding.

### EXAMPLES

Hereinafter, this invention will be described in more detail in conjunction with examples. The scope of this invention is not limited by the examples.

### Example 1

### Basic Properties and Biological Influence

1. Raw materials of the sample

1) Serpentinite quarried from Furano-city, Hokkaido and pulverized to 20-mesh or less.

2) Chrysotile quarried from Canada (grade: 4-class)

3) Asbestos recovered by inputting wave shaped asbestos slate (20 years had passed after construction: product of Nozawa KK) into pulverizing and separation equipment for recovering asbestos from serpentinite.

2. Treatment of sample

The above materials, each in an amount of 110 kg, were thrown into an acid solution containing 220 kg of water and 130 kg of 98% sulfuric acid and heated at 100° C., followed by stirring for 2 hours for decomposition.

A slurry obtained by the decomposition was collected by using a press filter, and a residue was washed with water until the rinse liquid was neutral and then dried in 100° C. hot air drying machine for 24 hours, followed by pulverization by using a ball mill to 200 mesh or less, thereby collecting silica. Since the obtained silica differ depending on test examples, the silica will be referred to as Example 1-1 silica, Example 1-2 silica, and the like for identification in the following description.

3. Tests for basic properties and biological influence

The following tests were conducted of the basic properties and the biological influence of the obtained silica.

a) Chemical composition (fluorescent X-ray analysis)

b) X-ray diffraction

c) Shape observation (transmission electron microscope)

d) Specific surface area (BET method)

e) Pore diameter and pore volume (gas adsorption method)

f) Bulk specific gravity (JIS K 5101)

g) Cell toxicity test (colony formation method)

h) Rat endotracheal instillation test

i) Biological fluid solubility test

### [Test Results]

### [Table 1]

TABLE 1
Basic Characteristics of Silica

| | | Ex. 1-2 | Ex. 1-3 | Comp. Ex. 1-1 | | Comp. Ex. 1-3 |
|---|---|---|---|---|---|---|
| | Ex. 1-1 | Asbestos from | Collected | Asbestos from | Comp. Ex. 1-2 | Magnesium |
| Test Items | Serpentine | Canada | Asbestos | Canada | Wollastonite | Sulfate Whisker |
| Chemical Composition | 96.6 | 97.1 | 96.8 | — | — | — |
| (SiO₂ %) | | | | | | |
| X-ray Diffraction | Amorphous | Amorphous | Amorphous | — | — | — |
| Specific Surface Area | 226 | 158 | 185 | — | — | — |
| (m²/g) | | | | | | |
| Pore Peak Radius (nm) | 0.9 | 2.4 | 1.6 | — | — | — |
| Pore Volume ml/g | 0.244 | 0.226 | 0.204 | | | |
| Bulk Specific Gravity | 0.3 | 0.1 | 0.2 | — | — | — |
| Cell Toxicity (μg/ml) *1 | >50 | >50 | >50 | <2 | >50 | — |
| Endotracheal | No fibrosis | No fibrosis | No fibrosis | Prominent | — | — |
| instillation test *2 | | | | fibrosis | | |
| Biological fluid | 31% | 32% | 30% | 0% | — | 25% |
| solubility test *3 | | | | | | |

*1: amount required for inhibiting colony formation rate by 50%
*2: absence/presence and degree of fibrosis in respiratory organ
*3: solubility (37° C., 24 hours) in synthetic physiological fluid (Gamble's fluid)
Shape observation photos are as follows.
The transmission electron microscopic photographs below were used.

### Example 2

### Application of Silica

### Wet-Type Finishing Material

(Preparation of Test Material)

Both the Example 1-1 silica and Example 1-2 silica were mixed with the components shown in Table 2, followed by adding an appropriate amount of water thereto, and a 3 mm-thick coating of each of the thus-obtained materials was applied on a gypsum board having a thickness of 9 mm, a length of 910 mm, and a width of 1,820 mm to evaluate workability and properties as an humidity conditioning interior finishing material. A commercially available material containing diatom earth was used as a comparative example.

The evaluation was conducted in accordance with JIS A 6909. The test methods according to JIS A 6909 are shown in Table 3, and results of the evaluation are shown in Table 2.

### [Table 2]

TABLE 2
Workability and Properties of Wet Finishing Material

| Material | | Ex. 2-1 | Ex. 2-2 | Ex. 2-3 | Ex. 2-4 | Comp. Ex. 2-1 |
|---|---|---|---|---|---|---|
| Composition | Silica(1-1) | 96 | 25 | | 15 | Diatom earth- |
| | Silica(1-2) | | | 25 | | based finishing |
| | Slaked lime | | 50 | 50 | 50 | material (57% |
| | Aggregate | | 21 | 21 | 26 | diatom earth) |
| | Pulp | 3 | 3 | 3 | 3 | |
| | Methylcellulose | 1 | 1 | 1 | 1 | |
| Workability | | ◯ | ⊚ | ⊚ | ◯ | Δ |
| Crack Resistance | | No crack | No crack | No crack | No crack | No crack |
| Impact Resistance | | Not particular | Not particular | Not particular | Not particular | Not particular |
| Impact Resistance | | Pass | Pass | Pass | Pass | Failed |
| Cleaning Resistance | | Pass | Pass | Pass | Pass | Failed |
| Moisture Absorption/Desorption (g/m²) | | 311 | 150 | 145 | 129 | 152 |
| Adhesion strength (N/mm²) | | 0.4 | 0.5 | 0.5 | 0.4 | 0.3 |
| Crack due to | Coating | No crack | No crack | No crack | No crack | No crack |
| Coating Thickness | thickness 1.0 mm | | | | | |
| | Coating | No crack | No crack | No crack | No crack | No crack |
| | thickness 3.0 mm | | | | | |
| | Coating | No crack | No crack | No crack | No crack | No crack |
| | thickness 5.0 mm | | | | | |

*Workability: overall evaluation of spreadability, heaviness, and nonadhesiveness using a trowel in coating
*Properties: complying with JIS A6909

### [Table 3]

TABLE 3
Evaluation according to JIS A 6909 “finishing coat composition for building”

| | | | Number | |
|---|---|---|---|---|
| | | Test Base | of | |
| Test Item | Measurement Standard | Material | Samples | Test Method |
| Resistance to | Absence of crack | Flexi 4 mm | 3 | Placed in parallel to air current of speed 3 m/s ± 10%, 20° C. and 65 RH in wind |
| Crack due to | | 300 × 150 | | tunnel, immediately after coating, and absence/presence of surface crack after 6 hrs |
| Initial | | | | was confirmed by visual observation |
| Drying | | | | |
| Cleaning | Absence of base | Flexi 6 mm | 3 | After being cured for 14 days after coating, a part having a length of 100 mm was |
| Resistance | exposure due to peeling | 430 × 170 | | brushed reciprocatingly for 300 times under a load of 4.41 N by using a washing |
| | and friction | | | test machine (Gardner straight line washability machine) and a brush dipped into a |
| | | | | soap solution. Test piece was continuously wetted with the soap solution. After |
| | | | | that, absence/presence of surface crack and base exposure were investigated by |
| | | | | visual observation. |
| Impact | Absence of crack, | Flexi 4 mm | 3 | After being cured for 14 days after coating, the test piece was retained horizontal in |
| Resistance | prominent modification, | 300 × 150 | | accordance with the method of the whole area being supported on sand as defined |
| | and peeling | | | in JIS A 1408, and then a spherical dead weight W2-500 was dropped from a height |
| | | | | of 30 cm. After that, absence/presence of surface crack, prominent modification, |
| | | | | and peeling from the base material were investigated by visual observation. |
| Alkali | Absence of crack, | Flexi 4 mm | 3 | Cured for 7 days after coating, and cured for 3 days after coating a back side with |
| Resistance | peeling, swelling, | 150 × 150 | | an epoxy resin. A 20° C. calcium hydroxide saturated aqueous solution was poured |
| (method A) | softening and elution as | | | into a beaker of 300 ml to a height of about 90 mm, and the test piece was placed |
| | well as absence of | | | vertically in the beaker for 24 hours. The surface was washed with water, |
| | prominent tarnish and | | | followed by wiping off the water. 3 hours later, surface crack and peeling were |
| | discoloration as | | | visually observed, and tarnish and discoloration were compared with those of the |
| | compared to a part not | | | part not dipped into the test solution. |
| | dipped | | | |
| Adhesion | Drawing resistance of | Flexi 4 mm | 3 | The test material was coated on a mortar cement plate and cured, and to a 4 cm × 4 cm |
| | 0.3 N/mm² or more | 300 × 150 | | section a pull-out tag was adhered with an epoxy adhesive agent. A cut line |
| | | | | was made around the part, and the pull-out test was conducted 24 hours later. |
| Workability | Ease of coating | | | Workability was evaluated by performing a test-coating on an actual wall. |

* Flexi: Flexible sheet (slate plate)
** Workability is not included in the test items complying with JIS.

### Example 3

### Properties as Dry Finishing Material

### Moisture Absorption/Desorption Property of Fibrous Silica and Strength of Cured Material

Example 1-1 silica, Example 1-3 silica, and a commercially available diatom earth were mixed with the components shown in Table 4, followed by adding thereto an appropriate amount of water and kneading. Each of the kneaded materials was charged into a mold form, followed by press-molding into the size of a width of 50 mm, a length of 200 mm, and a thickness of 10 mm (molding pressure: 2N/mm²). The molded articles were left to cure in a room at 20° C. for 2 weeks and then subjected to the property tests.

The test results are shown in Table 4.

### [Table 4]

TABLE 4
Properties of Dry Finishing Material

| | | Ex. | Ex. | Ex. | Ex. | Comp. Ex. |
|---|---|---|---|---|---|---|
| Materials | | 3-1 | 3-2 | 3-3 | 3-4 | 3-1 |
| Composition | Silica (1-1) | 100 | 70 | — | 30 | — |
| | Silica (1-3) | — | — | 70 | — | — |
| | Diatom Earth | — | — | — | — | 30 |
| | Slaked Lime | — | 30 | 30 | 70 | 70 |

| | | | | | |
|---|---|---|---|---|---|
| Moisture absorption/desorption | 385 | 335 | 325 | 142 | 123 |
| Property (g/m²) | | | | | |
| Flexural Strength (N/mm²) | 2.4 | 3.1 | 2.9 | 5.4 | 3.8 |

* Moisture absorption/desorption Property: JIS A6909
* Flexural Strength: 180 mm-span, centralized concentrated load

### Example 4

### Deodorizing Property of Fibrous Silica

Each of Example 1-1 silica, Example 1-2 silica, and a commercially available diatom earth was granulated by using a pan type granulating machine and adding thereto an appropriate amount of water into the size of about 1 to 2 mmφ, followed by drying in a room at 20° C. and 65% RH. After confirming that the granule mass has stabilized, a deodorization property test was conducted by the following method.

Each of the granules was put into an air-tight bag having an air content of 3 liters, followed by adjusting a test gas to a predetermined concentration. A gas concentration in the bag was measured at a constant interval by using a detection tube. Results of the test are shown in Tables 6 to 8 (in order to compare aptitude for the gas, comparison with partially activated carbon was conducted).

### [Table 5]

TABLE 5
Deodorizing Property Test 1: Toluene (gas concentration: ppm)

| | | Elapsed Time | | |
|---|---|---|---|---|
| Type of Granule | Amount | 0 | 30 minutes | 60 minutes |
| 1-1 Silica | 5 g | 100 | 5 | 2 |
| 1-2 Silica | ″ | 100 | 12 | 10 |
| Diatom Earth | ″ | 100 | 25 | 17 |
| Blank Test | — | 100 | 100 | 100 |

### [Table 6]

TABLE 6
Deodorizing Property Test 2: Formalin (gas concentration: ppm)

| | | Elapsed Time | | |
|---|---|---|---|---|
| Type of Granule | Amount | 0 minute | 5 minutes | 10 minutes |
| 1-1 Silica | 1 g | 20 | <1 | <1 |
| 1-2 Silica | ″ | 20 | 2 | <1 |
| Diatom Earth | ″ | 20 | 4 | 4 |
| Blank Test | — | 20 | 20 | 20 |

### [Table 7]

TABLE 7
Deodorizing Property Test 2: Methanol (gas concentration: ppm)

| | | Elapsed Time | | | |
|---|---|---|---|---|---|
| Type of | | 0 | | | 60 |
| Granule | Amount | minute | 10 minutes | 30 minutes | minutes |
| 1-1 Silica | 5 g | 500 | <20 | <20 | <20 |
| Active | ″ | 500 | 70 | 30 | <20 |
| Carbon | | | | | |
| Diatom Earth | ″ | 500 | 180 | 160 | 160 |
| Blank Test | — | 500 | 500 | 500 | 500 |

### [Table 8]

TABLE 8
Deodorizing Property Test 1: Hydrogen Sulfate
(gas concentration: ppm)

| | | Elapsed Time | | | |
|---|---|---|---|---|---|
| | | 0 | 30 | 60 | 180 |
| Type of Granule | Amount | minute | minutes | minutes | minutes |
| 1-1 Silica | 1 g | 100 | 80 | 60 | 20 |
| 1-2 Silica | ″ | 100 | 100 | 97 | 52 |
| Diatom Earth | ″ | 100 | 100 | 100 | 100 |
| Blank Test | — | 100 | 100 | 100 | 100 |

*In the above tables, “<” means that the gas concentration in the bag reached the detection limit.

### Example 5

### Application of Silica

### Water Retentive Cured Material

Example 1-1 silica, Example 1-3 silica, and a commercially available sepiolite were mixed as shown in Table 9, followed by adding thereto an appropriate amount of water and kneading. Each of the obtained compositions was charged into a molding form to be molded into the size of a width of 50 mm, a length of 200 mm, and a thickness of 10 mm. The molded articles were left to cure in a room at 20° C. for 1 week and then subjected to property tests. Results of the property tests are shown in Table 9.

### [Table 9]

TABLE 9
Properties of Water Retainable Cured material

| | | Ex. | Ex. | Comp. Ex. |
|---|---|---|---|---|
| Materials | | 5-1 | 5-2 | 5-1 |
| Composition | Silica (1-1) | 30 | — | — |
| | Silica (1-3) | — | 30 | — |
| | Sepiolite | — | — | 30 |
| | Cement | 70 | 70 | 70 |

| | | | |
|---|---|---|---|
| Water Absorption Rate (%) | 60 | 58 | 43 |
| Compressive Strength | 8.5 | 8.3 | 6.2 |
| (N/mm²) | | | |

*Water Absorption Rate: Each of the materials was dipped into water for 24 hours and then dried at 105° C. for 24 hours

As described in the foregoing, the curable composition obtained by decomposing chrysotile and/or chrysotile-containing serpentinite according to this invention is non-asbestos material, free from toxicity, and safely usable. Since the silica obtained by the decomposition has curing property as well as moisture absorption/desorption property, odor absorption property, and chemical substance absorption property, it is possible to obtain an excellent humidity conditioning finishing material and a dry finishing material when the silica is used for a finishing material.

### INDUSTRIAL APPLICABILITY

It is possible to safely use the curable composition of this invention since the curable composition the influence of chrysotile to a living body is substantially eliminated, and, since the material obtained by mixing the fibrous silica obtained by decomposition of chrysotile with acid with pulp has curing property as well as moisture absorption/desorption property, odor absorption property, and chemical substance absorption property, it is possible to obtain an excellent humidity conditioning finishing material and a dry-type finishing material by using the curable composition of this invention for a finishing material, and this material can be effectively used in the fields of interior building materials useful for improvement of indoor environment, and indoor finishing material.

1. A curable composition characterized by comprising a porous fibrous amorphous silica obtained by decomposing a chrysotile or a serpentinite containing a chrysotile with acid to substantially eliminate an influence of asbestos to living body.

2. The curable composition according to claim 1, characterized by including a reinforcing fiber and/or a surfactant and a thickener and/or a filler and/or a colorant in the curable composition.

3. The curable composition according to claim 1, characterized by including an air-hardening material and/or a water-hardening material and a thickener in the composition.

4. The curable composition according to claim 1, characterized by including:
15 to 100% of the porous fibrous amorphous silica obtained by decomposing a chrysotile or a serpentinite containing a chrysotile with acid;
0 to 75% of a slaked lime;
0 to 3% of the thickener;
0 to 10% of a pulp; and
0 to 75% of the filler.

5. The curable composition according to claim 3, characterized by including at least one of a methylcellulose, a starch glue, and a seaweed glue as the thickener.

6. A coating composition using the curable composition according to claim 1, the curable composition is characterized by comprising a porous fibrous amorphous silica obtained by decomposing a chrysotile or a serpentinite containing a chrysotile with acid to substantially eliminate an influence of asbestos to living body.

7. A cured material obtained by extrusion or press-molding, characterized by comprising a porous fibrous amorphous silica obtained by decomposing a chrysotile or a serpentinite containing a chrysotile with acid to substantially eliminate an influence of asbestos to living body.

8. A cured material obtained by extruding or press-molding the curable composition according to claim 1, the curable composition is characterized by comprising a porous fibrous amorphous silica obtained by decomposing a chrysotile or a serpentinite containing a chrysotile with acid to substantially eliminate an influence of asbestos to living body.
